(19) United States
(12) Patent Application Publication
(10) Pub. No.: US 2007/0196760 A1
(43) Pub. Date: Aug. 23, 2007

(54) Toner composition comprising polyester toner particles encapsulating a wax and method of producing same

(76) Inventors: Chul-Hwan Kim, Daejon (KR); Tae-Ho Park, Daejon (KR); Hyun-Nam Yoon, Towaco, NJ (US)

Correspondence Address: Susan P. Petraglia, No. 303, 116 Sixth Street, NE, Washington, DC, 20002, US

(21) Appl. No.: 11/790,852

(22) Filed: Apr. 27, 2007

Related U.S. Application Data
(63) Continuation of application No. 11/478,603, filed on Jul. 3, 2006, now abandoned.
Application No. 11/478,603 is a division of application No. 10/366,369, filed on Feb. 14, 2003, now abandoned.

(30) Foreign Application Priority Data
Feb. 15, 2002 (KR) 10-2002-0008077

(51) Int. Cl. G03G 9/08

(52) U.S. Cl. 430/137.1

(57) ABSTRACT

The invention pertains, in part, to a toner composition that is suitable for developing latent electrostatic images and being comprised of substantially spherical polyester particles with a volume average diameter in the range of 2-10 microns and which contain a wax component in the interior. The invention also pertains to a method of producing the toner composition, which is characterized by encapsulating a wax within resin particles by chemical milling a polyester resin and a wax in a polar solvent and in the further presence of an evaporable processing aid.

### CROSS REFERENCE TO RELATED APPLICATIONS

This application is a continuation of U.S. application Ser. No. 11/478,603, filed Jul. 3, 2006, which application is a divisional application of parent application Ser. No. 10/366,369, filed on Feb. 14, 2003, and which parent application claimed the benefit of foreign priority on Korean application 10-2002-0008077, filed Feb. 15, 2002.

### BACKGROUND OF THE INVENTION

The invention pertains generally to toner compositions suitable for developing electrostatic images in electrophotography and to dispersion comminution methods for producing such toners. More specifically, the invention relates to polyester toner particles which encapsulate a wax component in the interior and which particles are substantially spherical in shape. The particulate toner composition is suitable for oil-free fusing of developed images. In another embodiment the invention pertains to a dispersion comminution method which facilitates encapsulation of the wax component by forming a dispersion of polyester toner particles and the wax component in a polar dispersion medium.

An emerging trend in the laser printer field, especially in color laser printing, is a printer with a fusing unit that does not use a fuser oil. In order to produce a toner suitable for oil-free fusing, one must add a wax component to the toner composition. Two methods are available for wax incorporation; wax as an external additive to the toner composition, or encapsulation of a wax into the toner particles.

A toner composition in which a wax component is added as an external additive often develops a tendency to agglomerate when the toner composition is stored for an extended period. For this reason, the encapsulation of wax as an internal component of toner particles is favored.

Both physical and chemical methods are used to encapsulate wax in toner particles. A traditional physical method is dispersing a wax and other toner additives in a molten resin using high-shearing equipment, such as an extruder, and then producing toner particles by mechanically milling the mixture. However, that method makes it difficult to encapsulate a sufficiently large amount of wax in the particles for oil-free fusing. Furthermore, the toner particles tend to be irregular in shape and too large for high-resolution printing. Also, the distribution of wax in toner particles so produced tends to be non-uniform. For these reasons, chemical methods of producing toners encapsulating wax are being actively developed and increasingly employed.

An example of the chemical methods of producing toner particles containing wax is the so-called “emulsion aggregation method” disclosed, for example, in U.S. Pat. Nos. 5,916,725, and 6,268,103. In this method, an emulsion comprised of sub-micron size particles of a toner resin component that contains various toner additives and sub-micron particles of a wax is formed in an aqueous medium. The particles are then aggregated to form toner particles of a suitable size by changing a physical property of the dispersion medium, for example, the pH of the medium. The emulsion aggregation method, however, consists of several steps of considerable complexity and difficulty. The aggregation step requires long process time and extraordinary care in order to not disturb the stability of and risk collapsing the emulsion structure. Furthermore, the aggregation of small emulsion particles results in encapsulation of the dispersion medium, typically water, inside the aggregated particles and, therefore, necessitating an extremely long and costly drying step. This is further complicated by the fact that a toner resin typically has a low fusing temperature and therefore toner particles cannot be dried at a high temperature that would facilitate faster evaporation of the encapsulated dispersion medium.

Another example of chemical methods of producing toner particles containing a wax is the suspension polymerization method disclosed, for example, in U.S. Pat. No. 6,177,223. According to that method, a suspension of monomer droplets including a wax in a suspension medium and the monomer droplets are polymerized. Toner particles of a small and uniform size may be produced by that method but control of the polymerization in the suspension state is difficult. Also, the method produces toner particles with a smooth surface texture and, as a result, they tend to be slow in developing triboelectric charge.

Both of the methods described above, however, are applicable only for styrenic polymers which are polymerized by free radical polymerization. This is a significant limitation of the prior art methods because a polyester resin is preferred for manufacture of color toner and high-speed laser printer applications, due to its superior flow properties and colorant compatibility.

According to more conventional suspension or emulsion polymerization methods, a suspension or an emulsion of monomers is first formed in a dispersion medium and then the monomers are subsequently polymerized in situ. Water is the most frequently used dispersion medium. Therefore only those monomers that can be polymerized below the boiling point of water via a free radical polymerization, such as acrylate and styrene, are used in the methods. However, condensation polymers such as polyesters require high polymerization temperature well over the boiling point of water. Furthermore the polymerization temperature has to be raised over a wide range during the course of the polymerization. Therefore, a suspension or an emulsion polymerization method in an aqueous medium is not suitable for production of a polyester-based toner composition.

A polymerized polyester toner is disclosed in U.S. Pat. No. 6,001,524. According to that invention, a particulate polyester toner composition comprising spherical particles is produced by dispersion polymerization of finely dispersed polyester monomer in a paraffinic dispersion medium. The polymerization is carried out in the presence of a polymeric surfactant and by raising the temperature from about 150° C. to about 250° C., with subsequent recovery of the toner particles. While the method is effective for producing spherical polyester toners with small particle size suitable for high-resolution printing, the paraffinic medium does not allow encapsulation of wax in the toner particles. Hence the method cannot be used for production of toners for oil-free fusing.

Still another method of producing a toner composition is the so-called “chemical milling method”, disclosed, for example, in U.S. Pat. No. 6,287,742. According to that invention, polymer resin droplets of a suitable size for toner applications are formed directly in a dispersion medium utilizing the difference in the surface energies of the resin and of the medium. The starting raw materials of the chemical milling method is a fully developed polymer resin, rather than monomers as in the above-described polymerization methods. Therefore the chemical milling method does not require a polymerization step as a part of the process. Furthermore, any type of resins, not just a polyester resin, may be used. The disclosed process, however, uses a paraffinic dispersion medium and therefore encapsulation of a wax is not possible. Since the continuous-phase paraffin oil and the wax are chemically similar, during the course of the chemical milling the wax tends to exude from the resin particles and reside at the interface between the resin and the medium; this results in agglomeration of the toner particles.

Hence, a new method of producing a particulate polyester toner composition having substantially spherically-shaped polyester resin particles encapsulating a wax is highly desirable. Accordingly, the invention described below in fuller detail pertains to methodology for producing a toner composition suitable for developing latent electrostatic images using oil-free fusing, and to toner compositions so produced.

### BRIEF SUMMARY OF THE INVENTION

An objective of the present invention is to provide a particulate toner composition of polyester particles which encapsulate a wax in the interior of the particles. The particles are further characterized by being substantially spherical in shape with a volume average diameter in the range of about 2 to about 10 microns. A method of producing the described particulate toner composition is also an integral part of the invention.

Another objective of the present invention is to provide a method of producing a polyester particulate toner composition suitable for oil-free fusing wherein the toner particles encapsulate a wax and also incorporate a colorant which may be a functionalized colorant (i.e., having reactive functional groups). The method of this embodiment utilizes the self-emulsifying effects of the polyester resin component and the inclusion of a volatile processing aid dispersed in a strongly polar liquid medium, with subsequent removal of the volatile processing aid by an evaporation step.

Yet another objective of the present invention is to provide another method of producing a polyester particulate toner composition suitable for oil-free fusing wherein a wax is encapsulated in the resin particles. Again employing the self-emulsifying effects of the polyester resin component and the inclusion of a volatile processing aid dispersed in a strongly polar liquid medium, the method further includes a step of dispersion dyeing the resulting wax-containing particles.

Other aspects and advantages of the present invention will become apparent in the following detailed description and in the examples below.

### DETAILED DESCRIPTION OF THE INVENTION

In order to achieve the above-described industry objectives, the present invention provides a particulate toner composition comprising polyester particles having a wax encapsulated in the interior and being substantially spherical in shape with the volume average diameter in the range of about 2 to about 10 μm. More specifically, the present invention discloses a particulate toner composition comprising a polyester resin, a colorant, a charge control agent (CCA) and a wax, and wherein the polyester particles encapsulate the wax in their interior in an amount of from about 0.01 wt. percent to about 30 wt. percent.

The toner resin used in the present invention is a polyester resin. Conventional polymerization processes for toner preparation, such as suspension or emulsion processes, can only be used for styrene/acrylate copolymer resins. In contrast, the present toner preparative method is usable equally well for a styrene/acrylate copolymer and a polyester resin. Polyester resins generally have a superior melt flow property and compatibility with colorants and, therefore, they are preferred in the preparation of toners for color laser printer or high-speed printer applications. The reason for the enhanced properties and compatibility is that polyester resins contain polar ester linkages in their molecular chains and therefore have good compatibility with polar dye and pigment colorants. Additionally, if the chain units of the polyester resin include acidic or basic monomeric units, the resin can expeditiously form bonds with basic or acidic dye molecules, respectively. The bond-forming reactions are either an esterification or a charge transfer complex formation. As a result, the dyes are tightly bound to the resin, resulting in superior dye-fastness and water-fastness. The polyester resin may have functional sites in its polymer chain structure that are suitable for interacting with a colorant having reactive functional groups such as a functionalized dye. Such functional sites are exemplified by hydroxyl moieties, alkoxyl moieties, sulfonic or derivatized sulfonic moieties, carboxyl or derivatized carboxyl moieties, phosphonic or derivatized phosphonic moieties, phosphinic or derivatized phosphinic moieties, thiol moieties, amine moieties, alkyl amine moieties, quaternized amine moieties, and mixtures thereof.

The polyester particles useful in the practice of the invention are formed from a polyester resin starting material that is an amorphous resin with a number average molecular weight in the range of about 2,000 to about 10,000. The amount of polyester resin in the particulate toner composition according to the invention is in the range of about 70 weight percent to about 98 weight percent.

A key component of the toner composition of the present invention is the wax component, essential in the preparation of a particulate toner composition for oil-free fusing. Many different types of waxes may be encapsulated in the toner particles using the toner preparation method of the present invention. Examples of suitable waxes are ester waxes, Carnauba waxes, polyethylene waxes, polypropylene waxes and bee's wax. Among these, the ester waxes and the Carnauba waxes are preferred. The amount of wax encapsulated in the particles is in the range of about 0.01 wt. percent to about 30 weight percent.

As the colorant used in the present invention, commonly known pigments may be used. Illustrative black pigments may include carbon black, aniline black, non-magnetic ferrite and magnetite. Illustrative cyan pigments may include copper phthalocyanine compounds and derivatives thereof; anthraquinone compounds, and basic dye chelate compounds. Particularly preferred cyan pigments are C. I. Pigment Blue 1, 7, 15, 151, 152, 153, 154, 60, 62, and 66. Illustrative magenta pigments may include condensation azo compounds, diketopyropyrrole compounds, anthraquinone compounds, quinacridone compounds, basic dye chelate compounds, naphthol compounds, benzimidazole compounds, thioindigo compounds and perylene compounds. Particularly preferred magenta pigments are C. I. Pigment Red 2, 3, 5, 6, 7, 23, 482, 483, 484, 811, 122, 146, 166, 169, 177, 184, 185, 202, 206, 220, 221, and 254. Illustrative yellow pigments may include condensation azo compounds, isoindolinone compounds, anthraquinone compounds, azo metal complexes, methine compounds, and allylamide compounds. Particularly preferred yellow pigments are C. I. Pigment Yellow 12, 13, 14, 15, 17, 62, 74, 83, 93, 94, 95, 109, 110, 111, 128, 129, 147, 168 and 180.

Alternatively, a suitable dye may be used as the colorant of the present invention so long as it can be bound to the polymer resin. Preferred dyes include disperse dyes, basic dyes, acid dyes, or reactive dyes. The weight ratio to dye to particulate polymer resin is generally from about 1:100 to about 10:100 or from about 1 to about 10 percent by weight. Where the combination would produce an advantageous colorant property for the subject toner compositions, a suitable dye may be used in conjunction with one of the afore-mentioned pigments.

The colorants are selected based on the criteria of hue, chroma, brightness, weatherability, transparency and dispersibility in toner resins. The colorants may be used alone, in the form of a mixture, or in the state of a solid solution. Further, the colorant particles may be coated with a polymer film to facilitate dispersion of the particles in toner resins. The colorants may be added in the amount of from 1 to 20 parts by weight based on 100 parts by weight of the resin.

A suitable charge control agent may be incorporated into the particulate toner composition of the present invention. The charge control agent may be selected from positive-type or negative-type charge control agents, depending on the desired charge type of the toner composition. Examples of positive-type charge control agents are: nigrosine and products modified with fatty acid metal salts; quaternary ammonium salts such as tributylbenzylammonium 1-hydroxy-4-naphthosulphonate; and metal salts of higher fatty acids. Examples of negative-type charge control agents are: metal complexes of aromatic hydroxycarboxylic acid and aromatic dicarboxylic acids. Typical metals for inclusion in the charge control agents include, for example, aluminum, chromium, titanium, and zinc. The amount of charge control agent is typically in the range of 0 to about 10 weight percent, preferably, about 0.5 to about 7 weight percent.

The present invention also provides a method for producing a particulate toner composition comprising resin particles encapsulating a wax in the particle interior and suitable for development of latent electrostatic images. The method consists of the steps of

first, preparing a dispersion medium component by dissolving a surfactant and, optionally, a viscosity enhancer in a polar liquid medium under agitation at an elevated temperature;

second, preparing a resin mixture component by mixing a polyester resin, a wax, a colorant, and a charge control agent in an evaporable processing aid;

third, adding the resin mixture component of the second step to the dispersion medium component prepared in the first step and forming a dispersion at an elevated temperature; and

fourth, recovering toner particles by cooling the dispersion formed in the previous step and separating the particles from the dispersion medium.

The dispersion medium of the present invention is a polar liquid. During the chemical milling process, i.e., the step of forming fine droplets of resin components, the polar medium does not extract wax from the resin droplets. Rather the polar medium expedites the incorporation of wax inside the resin droplets. The reason for this is because wax is non-polar and being introduced in a molten state, has low compatibility with the polar medium. Another requirement for the dispersion medium is that it does not swell or dissolve the resin. There are many liquid compounds satisfying these requirements. Some examples are water, glycerol, ethylene glycol, propylene glycols, polyethylene oxides and polypropylene oxides. Among these, water is particularly preferred because of its environmental friendliness and low cost.

An evaporable processing aid is often used in order to facilitate the formation of resin particles. When the dispersion medium is a polar liquid, there are several physical requirements imposed on the processing aid. The processing aid should be insoluble in the polar liquid medium, its boiling point should be lower than that of the polar medium, and it should dissolve the resin and the wax at the processing temperature. The evaporable processing aid may be selected from one of ethyl acetate, acetone, tetrahydrofuran, Cellusolve and acetonitrile.

It is optional but advantageous to include a surfactant in the resin dispersion formation step of the present invention. Any surfactant displaying surface activity in a polar medium may be used. However, a surfactant which exhibits an HLB value greater than 10, more preferably greater than 15 in the polar medium is especially suitable. The surfactant may be selected from dodecyl sodium sulfonate, polyethylene oxide, sorbitol palmitate, polyethylene oxide laureate and the like.

Optionally, a viscosity enhancing agent may be included in the compositions and methods of the subject invention. More specifically, when water is the dispersion medium used in the present methods, its (water's) viscosity is too low to effectively reduce the resin droplet size during the milling step. Accordingly, a viscosity enhancer may be used to facilitate the particle formation process. The viscosity enhancer should be soluble in water by more than 1 weight percent, and preferably can be chosen from polyvinylpyrrolidone, polyvinylalcohol, and polyacrylic acid. The amount of the viscosity enhancer employed is typically from 0 weight percent to about 10 weight percent relative to the amount of resin in the particulate toner composition.

A particulate toner composition according to the invention and suitable for development of latent electrostatic images, being comprised of toner particles encapsulating a wax in the interior, is produced by a method consisting of the steps of

first, preparing a dispersion medium component by dissolving a surfactant and, optionally, a viscosity enhancer in a polar liquid medium under agitation at an elevated temperature;

second, preparing a resin mixture component by mixing a polyester resin, a wax, and a charge control agent in an evaporable processing aid;

third, adding the resin mixture component of the second step to the dispersion medium component of the first step and forming a dispersion at an elevated temperature;

fourth, recovering toner particles by cooling the dispersion formed in the previous step and separating the particles from the dispersion medium; and

fifth, dispersion dyeing the recovered particles using a dispersion dyeing method. An art-recognized dispersion dyeing method may be employed in the last step of this embodiment, such as the method disclosed, for example, in U.S. Pat. No. 6,387,583.

In accordance with the present invention, the term “volume average particle size” is defined in, for example, Powder Technology Handbook, 2nd edition, by K. Gotoh et al, Marcell Dekker Publications (1997), pages 3-13. More specifically, it is preferable to produce toner particles of a narrow size distribution such that 80 weight % of the particles have the diameter within the range of about 0.5 to about 1.5 times the volume average diameter. The preference for toner particles with a narrow particle size distribution is because such a narrow size distribution provides toner particles that have uniform quantity of electric charge in each toner particle. Consequently, such toners provide high-quality copy images and facilitate charge control in a development unit. In the practice of the present invention, the particle size distribution is determined using a commercially available Coulter LS particle size analyzer (made by Coulter Electronics Co., Ltd., St. Petersburg, Fla.).

In accordance with the present invention, the span value is a measure of the narrowness of the particle diameter distribution and is defined as the ratio of the diameter range in which the middle 80 percent by volume of the particles occupy, to the median diameter. More specifically, the span value is defined by the formula
Span=(d₉₀−d₁₀)/d₅₀,

where d₁₀ is the diameter value at which the volume fraction is 10 percent by volume in the cumulative volumetric diameter distribution diagram, d₉₀ is the diameter value at which the volume fraction is 90 percent and d₅₀ is the diameter value at which the volume fraction is 50 percent. Therefore, a smaller span value means a narrow distribution of the particle diameter.

All of the foregoing embodiments as well as other embodiments within the spirit and scope of the invention will become further apparent in the following illustrative and non-limiting examples.

### EXAMPLE 1

Into a 1-liter reactor equipped with a condensing column and an agitator, 70 g of water, 0.1 g of poly-(vinyl-pyrrolidone) (PK-30, ISP Corporation, Wayne, N.J.) and 0.2 g sodium dodecyl sulfate (Junsei Chemical Co. Ltd, Tokyo, Japan) were introduced. The reactor contents were maintained at about 80° C. and the agitator speed at about 100 rpm.

Separately, in a beaker, 10 g of a polyester resin (available from DPI Solutions, Inc., Seoul, Korea) and 0.75 g of a wax (Wax S, Clariant Corporation, Charlotte, N.C.) were dissolved in 20 g of ethyl acetate (Aldrich Chemicals, Milwaukee, Wis.) at 70° C. Subsequently, the ethyl acetate solution was slowly poured into the reactor under the above-stated agitation conditions. The reactor contents quickly turned into a milky dispersion. The reactor temperature was maintained at 80° C. so that ethyl acetate evaporated out of the reactor. The evaporation step was continued until the amount of the condensate reached 20 g. Then the temperature was lowered to ambient temperature to obtain a dispersion of resin particles in water. The particles were washed three times using distilled water and then filtered away from the aqueous wash.

The filtered particles were dried under vacuum at 45° C. for 12 hours to obtain white resin particles. The volume average diameter was 6.2 μm and the 80% span value was 0.65.

### EXAMPLE 2

Into a 1-liter reactor equipped with a condensing column and an agitator, 70 g of water, 0.1 g of poly-(vinyl-pyrrolidone) (PK-30, ISP corporation, Wayne, N.J.) and 0.2 g sodium dodecyl sulfate (Junsei Chemical Co. Ltd, Tokyo, Japan) were introduced. The reactor contents were maintained at about 80° C. and the agitator speed at about 100 rpm.

Separately, in a beaker, 10 g of a polyester resin (available from DPI Solutions, Inc., Seoul, Korea) and 0.75 g of a wax (Wax S, Clariant Corporation, Charlotte, N.C.) were dissolved in 20 g of ethyl acetate (Aldrich Chemicals, Milwaukee, Wis.) at 70° C. Subsequently, 0.2 g of Astrazon Blue BG 200 (CI Basic Blue 3 dye available from DyStar L. P., Charlotte, N.C.) was dissolved in the ethyl acetate solution. Then the resulting solution was slowly poured into the reactor under the above-stated agitation conditions. The reactor contents quickly turned into a blue dispersion. The reactor temperature was maintained at 80° C. so that ethyl acetate evaporated out of the reactor. The evaporation step was continued until the amount of the condensate reached 20 g. The temperature was lowered to ambient temperature to obtain a dispersion of cyan toner particles in water. The particles were washed three times using distilled water and then filtered away from the aqueous wash. The filtered particles were dried under vacuum at 45° C. for 12 hours to obtain cyan toner particles. The volume average diameter was about 6.0 μm and the 80% span value was 0.50.

### EXAMPLE 3

Cyan toner particles were prepared following the same procedure described in Example 2 except that the agitation speed was 70 rpm during the dispersion forming stage. The volume average diameter was about 10.0 μm and the 80% span value was 0.70.

### EXAMPLE 4

Cyan toner particles were prepared following the same procedure described in Example 2 except that the agitation speed was 150 rpm during the dispersion forming stage. The volume average diameter was about 3.0 μm and the 80% span value was 0.65.

### EXAMPLE 5

Cyan toner particles were prepared following the same procedure described in Example 2 except that 0.5 g of CI Pigment Blue with the C. I. Constitution No. 74160 (HELIOGEN® Blue D7100 available from BASF Corporation, Charlotte, N.C.) instead of the 0.2 g of Astrazon Blue BG 200. The volume average diameter was about 8.0 μm and the 80% span value was 0.72.

While the invention has been specifically illustrated and described in connection with numerous embodiments and further defined in the appended claims, modifications to the various embodiments are within the spirit and scope of the present invention and will be readily apparent to those of skill in the art.

What is claimed is:

1. A method of producing a particulate toner composition suitable for development of latent electrostatic images and comprised of resin particles encapsulating a wax component, consisting of the steps of:
a) preparing a dispersion medium component by dissolving a surfactant and, optionally, a viscosity enhancer in a polar liquid medium under agitation at an elevated temperature;
b) preparing a resin mixture component by mixing a polyester resin, a wax, a colorant, and a charge control agent in an evaporable processing aid;
c) adding said resin mixture component of step b) to said dispersion medium component of step a) and forming a dispersion at an elevated temperature; and
d) recovering toner particles by cooling said dispersion of step c) and separating particles from the dispersion medium.

2. A method of producing a particulate toner composition according to claim 1, wherein said polar liquid medium is selected from the group consisting of water, glycerol, ethylene glycol, propylene glycol, and diethylene glycol.

3. A method of producing a particulate toner composition according to claim 2, wherein said polar liquid medium is water.

4. A method of producing a particulate toner composition according to claim 3, wherein said elevated temperature of step c) is in the range of about 60° C. to about 95° C.

5. A method of producing a particulate toner composition according to claim 1, wherein said evaporable processing aid is insoluble in said polar liquid medium and has a lower boiling point relative to said polar liquid medium.

6. A method of producing a particulate toner composition according to claim 1, wherein said evaporable processing aid solubilizes said wax at greater than about 5 weight percent.

7. A method of producing a particulate toner composition according to claim 1, wherein said evaporable processing aid is selected from the group consisting of ethyl acetate, acetone, tetrahydrofuran, Cellusolve and acetonitrile.

8. A method of producing a particulate toner composition according to claim 1, wherein said surfactant has an HLB value greater than 10.

9. A method of producing a particulate toner composition according to claim 8, wherein said surfactant is selected from the group consisting of dodecyl sodium sulfonate, polyethylene oxide, sorbitol palmitate and polyethylene oxide laureate.

10. A method of producing a particulate toner composition according to claim 3, wherein a viscosity enhancer is utilized and is soluble in water by more than 1 weight percent.

11. A method of producing a particulate toner composition according to claim 1, wherein said viscosity enhancer is selected from the group consisting of polyvinylpyrrolidone, polyvinylalcohol, and polyacrylic acid.

12. A method of producing a particulate toner composition according to claim 1, wherein said viscosity enhancer is present in an amount of 0 to about 10 parts per hundred relative to the amount of said polyester resin.

13. A method of producing a particulate toner composition according to claim 1, wherein said colorant is selected from the group consisting of pigments and dyes.

14. A method of producing a particulate toner composition suitable for development of latent electrostatic images and comprised of toner particles encapsulating a wax consisting of the steps of:
a) preparing a dispersion medium component by dissolving a surfactant and, optionally, a viscosity enhancer in a polar liquid medium under agitation at an elevated temperature;
b) preparing a resin mixture component by mixing a polyester resin, a wax and a charge control agent in an evaporable processing aid;
c) adding said resin mixture component of step b) to said dispersion medium component of step a) and forming a dispersion at an elevated temperature;
d) recovering toner particles by cooling said dispersion of step c) and separating particles from the dispersion medium; and
e) dispersion dyeing the toner particles recovered in step d).
